(19) United States
(12) Patent Application Publication
(10) Pub. No.: US 2005/0161002 A1
(43) Pub. Date: Jul. 28, 2005

(54) Safe stall grill enclosure system

(76) Inventor: Wayne G. Robinson, Douglassville, PA (US)

Correspondence Address: Steven Grossman, Esq., Grossman, Tucker, Perreault & Pfleger, 55 South Commercial Street, Manchester, NH, 03101, US

(21) Appl. No.: 11/017,068

(22) Filed: Dec. 20, 2004

Related U.S. Application Data
(60) Provisional application No. 60/530,503, filed on Dec. 18, 2003.

(51) Int. Cl. A01K 1/00

(52) U.S. Cl. 119/516

(57) ABSTRACT

The present invention relates to a horse stall or a stall or other animal containing a portion that has a series of bars. The bars are made of a flexible material and may deflect when a side load is applied. The bars may be removable affixed to a top and base support member.

### RELATED APPLICATIONS

This application claims the benefit of U.S. Provisional Application Ser. No. 60/530,503 filed Dec. 18, 2003.

### FIELD OF INVENTION

The present invention relates to horse stalls. More particularly, the present invention relates to the use of flexible bar members in the horse stall to control animal limb or head trauma.

### BACKGROUND

Animal stalls are typically constructed of wood or steel. Within one or more of the stall side walls, a grill consisting of equally spaced, vertical bars provide visibility into the stall while still containing the animal. Horse stalls vary in size, but the typical size of a horse stall enclosure is 10′×10′. Within the stall, the horse is free to move. The bars are positioned approximately 3.5′ to 5′ up from the base of the stall enclosure and extend to the top of the stall enclosure. The bar grill is positioned at an elevation that starts at the base of the horse's neck and extends to the height of the horse's head. The bars are made of a rigid material, typically steel. The bars are equally spaced around the enclosure at a distance ranging from 1.5″-3.5″.

During the time that a horse is confined within a stall, the horse may rollover onto its back, referred to as a cast position. While in the cast position, the horse's legs extend into the air and one (or more) of the horse's legs can become lodged between the bars within the stall grill. Serious injury occurs because the horse is unable to free the leg and is unable to return to an upright position.

It is an object of the present invention to control trauma and serious injury to the horse by incorporating a series of bars that are flexible (or compliant) or pop out of the stall. It is a further object of the present invention that should a horse's leg become entangled between the bars during a rollover maneuver, the bars flex, allowing the horse to free the entangled limb. It is also an object of the present invention to create a less hazardous and safer living environment for the horse.

It is also an object of the present invention to use lower cost materials such as plastic or composite materials. It is a further object of the present invention that the bars herein may be readily installed into existing stalls and provide an advantageous retrofit design. It is also an object of the present invention to support a wide range of live stock applications.

### SUMMARY OF THE INVENTION

The present invention relates to an animal stall comprising a top member, a base member and a plurality of longitudinal members affixed between said top member and said base member. The longitudinal members comprise flexible material wherein said flexible material is characterized as having the ability to releasably engage with an animal limb when said limb is lodged between said longitudinal members.

### BRIEF DESCRIPTION OF THE DRAWINGS

The following figures are illustrative examples of various embodiments of the present invention. It is understood that these figures are merely illustrative and thus, other configurations may be used in the present invention.

FIG. 1a is a top view of an embodiment of a support member for the bars used in the present invention.

FIG. 1b is a side view of an embodiment of a support member for the bars used in the present invention.

FIG. 2 is a side view of an embodiment of bar spacing used in the present invention.

FIG. 3a is illustrative of an embodiment of how the bars are fit into the support member in the present invention.

FIG. 3b is a side view of the present invention of an embodiment of a metal base support for the bars.

FIG. 3c is a side view of the present invention of an embodiment of a wood base support for the bars.

### DESCRIPTION OF THE INVENTION

The present invention relates to horse stalls or a stall used generally for livestock. More particularly, the present invention relates to the use of flexible bar members in the stalls to address the issue of animal limb or head trauma.

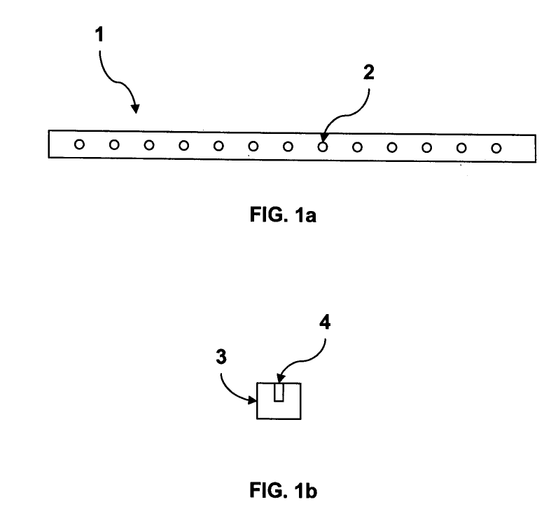

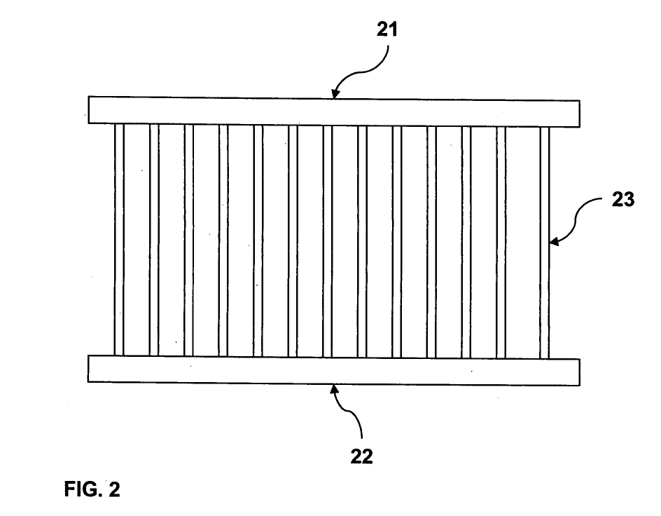

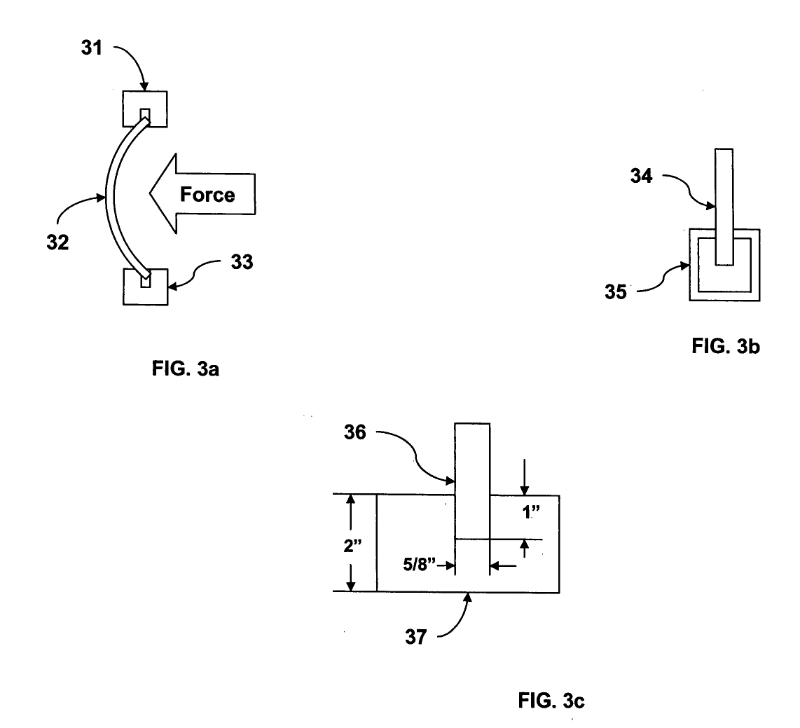

In one embodiment, a stall has a number of walls wherein one of or a portion of the stall walls includes a grill. FIG. 1a and FIG. 1b depicts either a top member (or base member) 1 having a number of holes 2 into which bars are placed. Turning to FIG. 2, the grill may include a top member 21 and a base member 22, in-between which a number of bars or longitudinal members 23 may be affixed. Preferably, as seen in FIG. 3b and FIG. 3c, the base member and the top member may be metal 35 or wood 37; however, the members may also comprise a plastic material or a composite material. Furthermore, the bars may be affixed in a manner that allows for removal of the bars.

In one embodiment, the stall grill may be composed of a series of vertical bar members that are equally spaced. The bars may be assembled into 2-horizontal members at the base and top of the bars. It should be appreciated that the bar members may be arranged in alternative manner including but not limited to horizontal and angular, depending on the needs dictated by livestock housed in the stall.

Preferably, the bars may be constructed using a wide range of materials, for example, thermoplastics, thermosets, composites, etc. that deflect when a side load is imposed. This is depicted in FIG. 3a where a bar 32 is shown to deflect in the top and bottom members 31 and 33, respectively, upon application of a force. In one embodiment, the bars are designed not to shatter when a side load is applied. Preferably, the bars have a flexural modulus (measured. according to ASTM D790) of between 350,000 psi to 500,000 psi, and any interval there between, including but not limited to 400,000 psi to 475,000 psi, 425,000 psi to 450,000 psi, etc. Most preferably the flexural modulus is about 410,000 psi. Also more preferably, the bars have a flexural strength (measured according to ASTM D790) of between 5,000 psi and 25,000 psi, and any interval therebetween, including but not limited to 10,000 and 20,000 psi, 12,000 to 16,000 psi, etc. Most preferably, the flexural strength is about 15,000 psi.

Expanding on the above, it can be appreciated that according to the present invention, the bars may be selected that for a given animal, in the event that the animal's limbs somehow become lodged in the bars, the bars have the characteristics that they may flex and allow the animal to, on its own, remove itself from an otherwise dangerous condition. In that sense, the bars contribute to the safety of the animal and ensure that the animal does not risk serious injury should the animal find itself in a situation where one of its limbs is inadvertently lodged in the bars and the animal struggles to free itself from such condition. It shall also be appreciated that depending upon the animal, various flexibilities may be selected which correspond to the particular animal's needs.

Alternatively, the bars may be designed such that when the animal's limbs become lodged therein, the bars may release from either of the top or base member. This then provides yet another mechanism for the bars to releasably engage and provide the animal with a self-enabling measure of safety.

In another embodiment, the bars are corrosion resistant. Preferably, the bars are made of non-toxic material for intimate contact with live stock. More preferably, the bars should retain physical properties for flexibility and shatter resistance over an operating temperature range of −20 F to 120 F. In one embodiment, the bars may be made of ⅝″ diameter chlorinated polyvinyl chloride (CPVC) tubing from Harvel Plastics, Inc., Easton, Pa.

It should be appreciated that the bars may be solid or hollow and may be of any circular, oblong or rectangular cross section. Preferably, the bar height can be adjusted to fit a given stall construction. In one embodiment, the bar height is between 24″ to 36″. Preferably the bars are 30″ in height. In another embodiment, the spacing between the bars may be no less than 2 inches. Preferably, the spacing between the bars is between 2 inches and 3 inches. However, as noted, such dimensions are all variable depending upon the particular animal and the particular situation of safety that must be addressed.

In another embodiment, the bars can be readily replaced should the bars be pushed out of the grill. Replacement bars may be designed to be installed on-site by an operator. It should be appreciated that the grill can be sized to fit standard stall enclosures for horses of all varying size and weight. Furthermore, it should be appreciated that the safe grill can also be customized to fit a wide range of stall constructions.

The foregoing description is provided to illustrate and explain the present invention. However, the description hereinabove should not be considered to limit the scope of the invention set forth in the claims appended here to.

1. An animal stall comprising a top member, a base member and a plurality of longitudinal members affixed between said top member and said base member
said longitudinal members comprising flexible material wherein said flexible material is characterized as having the ability to releasably engage with an animal limb when said limb is lodged between said longitudinal members.

2. The stall of claim 1, wherein said top member and said bottom member comprises a material selected from the group consisting of metal, wood, plastic, composites and mixtures thereof.

3. The stall of claim 2 wherein said top member and said bottom member are different materials.

4. The stall of claim 1 wherein said longitudinal members comprise a material that has a flexural modulus of between about 390,000 psi and 470,000 psi.

5. The stall of claim 1 wherein said longitudinal members comprise a material that has a flexural strength of between about 12,000 psi and 18,000 psi.

6. The stall of claim 1 wherein said longitudinal members comprise a material selected from the group consisting thermoplastics, thermosets, composites and mixtures there of.

7. The stall of claim 1 wherein said longitudinal members comprises chlorinated polyvinyl chloride.

8. The stall of claim 1 wherein said longitudinal members are flexible and shatter resistant between temperatures of about −20 F to 120 F.

9. The stall of claim 1 wherein said longitudinal members are corrosion resistant.

10. The stall of claim 1 wherein said longitudinal members are non-toxic for intimate contact with animals.

11. The stall of claim 1 wherein said longitudinal members have a cross-section selected from the group consisting of circular, oblong, rectangular and mixtures there of.

12. The stall of claim 1 wherein said longitudinal members have a height between 24 inches to 36 inches.

13. The stall of claim 1 wherein said spacing is between about 2 inches to 3 inches.

14. The stall of claim 1 wherein said longitudinal members are embedded into said top member and base member at a depth of at least 1 inch.

15. The stall of claim 1 wherein said flexible material that is characterized as having the ability to releasably engage with an animal limb when said limb is lodged between said longitudinal members comprises a bar that releases itself from said top member or said base member.

16. A stall member comprising:
a top member, a bottom member and a plurality of flexible longitudinal members removably engaged to said top and bottom members wherein said flexible longitudinal members comprise of a material that has a flexural modulus of about 410,000 psi and a flexural strength of about 15,000 psi and said flexible longitudinal members have a spacing of no less than 2 inches.

17. The stall member of claim 16 wherein said longitudinal members are flexible and shatter resistant at a temperature of between −20 degrees F. and 120 degrees F.

18. The stall member of claim 16 wherein said longitudinal members comprise a material selected from the group consisting of thermoplastics, thermosets, composites and mixtures thereof.

19. The stall member of claim 16 wherein said longitudinal member comprises chlorinated polyvinyl chloride.

20. A method of providing an animal stall to contribute to the safety of an animal having limbs contained therein comprising:
providing a top member, a base member and a plurality of longitudinal members affixed between said top member and said base member;
said longitudinal members comprising flexible material wherein said flexible material is characterized as having the ability to releasably engage with said animal limb when said limb is lodged between said longitudinal members.
